(19) United States
(12) Patent Application Publication
(10) Pub. No.: US 2005/0204015 A1
(43) Pub. Date: Sep. 15, 2005

(54) Method and apparatus for generation and transmission of computer graphics data

(76) Inventors: Jonathan E. Steinhart, McMinnville, OR (US); Michael A. Zuhl, Lake Oswego, OR (US)

Correspondence Address: SMITH-HILL AND BEDELL, P.C., 16100 NW CORNELL ROAD, SUITE 220, BEAVERTON, OR, 97006, US

(21) Appl. No.: 11/029,208

(22) Filed: Jan. 3, 2005

Related U.S. Application Data
(60) Provisional application No. 60/552,230, filed on Mar. 11, 2004.

(51) Int. Cl. G06F 15/16; G09G 5/00

(52) U.S. Cl. 709/217; 345/1.1

(57) ABSTRACT

A computer generates data directly in a form encoded for transmission over a network.

### CROSS-REFERENCE TO RELATED APPLICATIONS

This application claims the benefit of Provisional Application No. 60/552,230 filed Mar. 11, 2004, the entire disclosure of which is hereby incorporated by reference herein for all purposes. Subject matter disclosed in this application might be considered to be related to subject matter disclosed in patent application Nos. (Attorney Docket ZUHL 2850) and (Attorney Docket ZUHL 2851), the entire disclosure of each of which is hereby incorporated by reference herein for all purposes.

### BACKGROUND OF THE INVENTION

This invention relates both to computer graphics display generation and remote access to information generated by a computer for display.

One application of computers is the generation of information for display in remote locations.

Early computer architectures made this fairly easy to do. All output from the computer could be directed over a single, low-bandwidth console serial interface. A remote display could easily be connected via a modem.

Modern computer architectures, most notably the IBM PC architecture, utilize graphical consoles. The output from these computers is high bandwidth analog or digital video which is usually connected to a local video monitor. These interfaces are not suitable for long distance transmission.

The operation of PC architecture computers takes place in several stages. On power-up, the BIOS displays start-up messages on the console. A number of different configuration dialogs may be entered. A boot loader may be invoked through which the user may select an operating system. The operating system then starts up, generating various messages. A large variety of programs may then be run on top of the operating system. Upon exiting the operating system a number of shut-down messages are displayed on the console.

Several software packages exist that facilitate remote display and access. Some of these packages use standard networking protocols so that a remote display can be an almost unlimited distance from the computer. However, these packages run on top of the operating system and therefore cannot handle the start-up, configuration, boot loader, operating system start-up, and shut-down messages. Therefore, software packages don't work, for example, in an application where a remote display is desired for system configuration training.

Hardware support for remote displays exists in the form of video extension cables and repeaters. KVM (Keyboard, Video, Mouse) switches funnel the video to a remote display and can serve as video repeaters. Newer KVM products digitize the video for transmission over moderately longer but still limited distances. Such hardware does not have the software limitation of requiring the operating system to be running. However, while they allow a remote display to be located further from the computer, the distance is effectively limited to hundreds of feet. Also, it is difficult to connect multiple displays because of timing differences between monitors and identification information that monitors provide to display hardware.

### SUMMARY OF THE INVENTION

In accordance with a first aspect of the invention there is provided a remote access device for use with a local computer to allow a remote computer to interact with the local computer, said remote access device comprising a local computer interface for receiving signals from, and transmitting signals to, a bus of the local computer, a graphics circuit for receiving graphics messages from the local computer and converting the graphics messages to image data, an encoder for receiving the image data and packaging the image data for transmission, and a communication interface for receiving the packaged image data and transmitting the packaged image data over a communication medium to the remote computer.

In accordance with a second aspect of the invention there is provided a computer system comprising a local computer having a bus and a communication interface, a remote computer having a processor, a user interface including a display monitor, and a communication interface, a communication medium for communicating messages between the communication interfaces of the local and remote computers, and a remote access device comprising a local computer interface for receiving signals from, and transmitting signals to, the bus of the local computer, a graphics circuit for receiving graphics messages from the local computer and converting the graphics messages to image data representing an image, an encoder for receiving the image data, packaging the image data for transmission, and delivering the packaged image data to the communication interface of the local computer for transmission over the communication medium to the communication interface of the remote computer, and wherein the communication interface of the remote computer delivers the packaged image data to the processor of the remote computer, and the remote computer is programmed to display a replica of said image on the display monitor.

In accordance with a third aspect of the invention there is provided a computer system comprising a local computer having a bus, a remote computer having a processor, a user interface including a display monitor, and a communication interface, a remote access device comprising a local computer interface for receiving signals from, and transmitting signals to, the bus of the local computer, a graphics circuit for receiving graphics messages from the local computer and converting the graphics messages to image data representing an image, an encoder for receiving the image data and packaging the image data for transmission, and a communication interface for receiving the packaged image data and transmitting the packaged image data, a communication medium for transmitting the packaged image data from the communication interface of the remote access device to the communication interface of the remote computer, and wherein the communication interface of the remote computer delivers the packaged image data to the processor of the remote computer, and the remote computer is programmed to display a replica of said image on the display monitor.

An embodiment of this invention is a graphical output device that attaches to a computer. It appears as a console output device to that computer. Unlike existing devices, it produces compressed digital data directly for transmission to a remote display. The data produced is in a form suitable for transmission over long haul networks. Since an embodiment of this invention is indistinguishable from a console device to the computer, all information that would appear on the console, including start-up and shut-down information, is transmitted to the remote display. An embodiment of the invention provides the display of all console information as with the hardware products in concert with the virtually unlimited distance of the software products. Multiple remote displays can be driven from by a single device embodying the invention since monitor specific timing and identification information is eliminated.

### BRIEF DESCRIPTION OF THE DRAWINGS

FIG. 1 is a schematic block diagram of traditional video display hardware prior art.

FIG. 2 is a schematic block of an embodiment of the invention that highlights the differences between it and traditional video display hardware.

FIG. 3 is a schematic block diagram of the hardware in the preferred embodiments of the invention. The relationship between the hardware blocks and the blocks shown in FIG. 2 is shown.

FIG. 4 is a block diagram of the firmware in the preferred embodiments of the invention.

### DETAILED DESCRIPTION

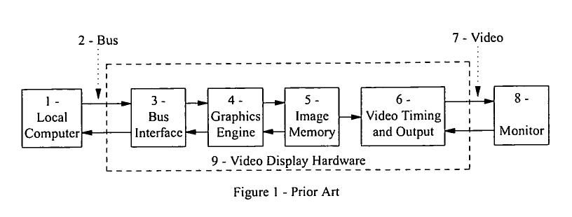

A block diagram of typical prior-art computer video display hardware is shown in FIG. 1.

The video display hardware 9 has a bus 2 connection to the local computer 1 and a video 7 connection to the monitor 8. The bus interface 3 manages the connection between the video display hardware 7 and the local computer 1. A graphics engine 4 interprets requests received from the local computer 1. These requests both draw into and read image data from the image memory 5. The video timing and output 6 circuitry converts the contents of the image memory 5 into an analog or video 7 data stream for the monitor 8. The graphics engine 4 includes a mechanism that allows the local computer 1 to directly read and write the image memory 5.

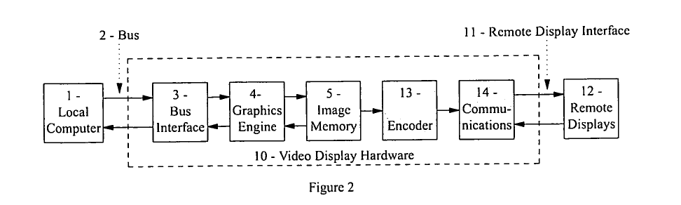

A block diagram of an embodiment of the invention is shown in FIG. 2. The video display hardware 10 in the embodiment of the invention is identical to conventional video display hardware 9 from the perspective of the local computer 1. However, the data in the image memory 5 is transmitted to the display(s) in a completely different manner.

The encoder 13 takes image data from the image memory 5. It packages this image data for transmission. The packaging includes compression to reduce the size of the transmitted data. The encoder in the preferred embodiments compresses the image using the RFB (Remote FrameBuffer) protocol that is the basis of the open source VNC (Virtual Network Console) software.

The communications 14 block transmits the compressed image data produced by the encoder 13 to to remote displays 12-3-over a network. The communications 14 block in the preferred embodiments implements the TCP/IP protocols. The preferred embodiments use Ethernet as the remote display interface 11.

As can be seen by comparing FIGS. 1 and 2, the embodiment shown in FIG. 2 is a drop-in replacement for conventional video display hardware. It replaces the video interface to the monitor in the conventional video display hardware with a network connection to remote displays. It allows remote displays to be located much further away from the computer than is possible with conventional video display hardware.

Remote displays 12 interpret RFB protocol messages from an embodiment of the invention, using the information contained to reproduce the contents of the image memory 5 on their own monitor. Typical remote displays 12 are computers that include a network interface and traditional video display hardware.

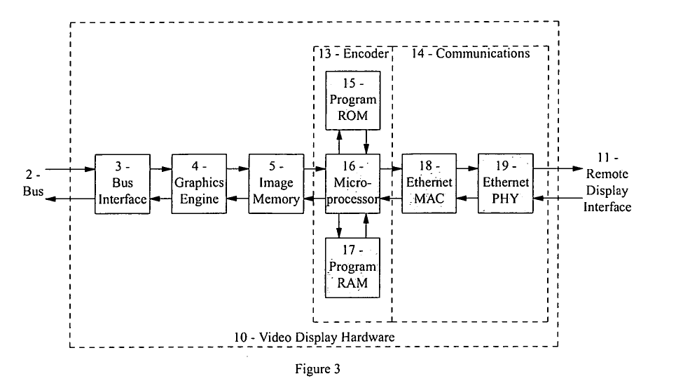

A schematic block diagram of the hardware for the preferred embodiments of the invention is shown in FIG. 3. This diagram adds detail to the overall block diagram in FIG. 2 above.

The bus interface 3, graphics engine 4, and image memory 5 are similar to those used in traditional video display hardware 9.

The encoder 13 utilizes a microprocessor system to perform the encoding in firmware. The microprocessor system includes a microprocessor 16 along with its associated program ROM 15 and program RAM 17. The encoder converts data from the image memory 5 to compressed image data. The encoder shares the microprocessor system with the communications 14 block.

The communications block consists of two components: the Ethernet MAC 18 (Media Access Controller) and the Ethernet PHY 19 (PHYsical interface). The encoder microprocessor system is used by the communications block to provide control for the Ethernet MAC and higher level functions such as TCP/IP support.

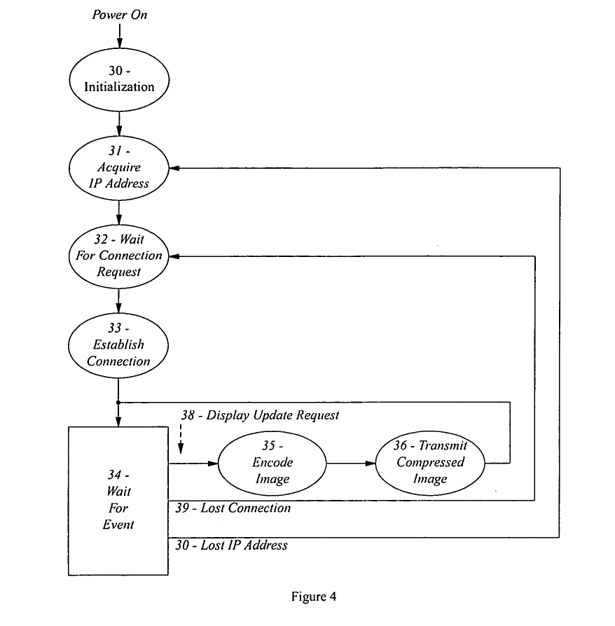

FIG. 4 is a block diagram of the firmware in the preferred embodiment of the invention.

The firmware performs initialization 30 after power-on.

The initialized system has an Ethernet address set by the communications 14 block. It maps that to an IP (Internet Protocol) address in the acquire IP address 31 block. There are several possible ways to acquire an IP address due to the evolution of the Internet. The system tries to acquire an address using DHCP, RARP, and BOOTP.

A remote display can connect to the preferred embodiment of the invention once an IP address is established. The preferred embodiment of the invention waits for a request from the remote display in the wait for connection request 32 block.

A connection with the remote display is established in the establish connection block 33 after a connection request is received. This may include handshaking to agree on compression methods and data formats that can be handled by both ends of the connection.

Steady state operation begins once the connection is established. The preferred embodiment of the invention waits for an internal or external event as shown in Wait For Event 34 and then processes the event. There are three events:
1. A lost IP address 30, in which case the system goes back to 31 to get a new one,
2. A lost connection 39, in which case the system goes back to 32 to get a new one, or
3. A display update request 38 indicating that new data should be sent to the remote display.

A display update request 38 can occur for several reasons. These include:
1. An amount of time has elapsed,
2. Sufficient changes have occurred to the information to be displayed, and
3. A remote display 12 has requested an update.

The encode image 35 block compresses image data for transmission in response to a display update request 38. The encoding reduces the amount of data that needs to be transmitted. The encoding may accomplish this by only sending the changes in the image between updates, by mathematically minimizing the number of bits, or a combination of the two. Encoding may also use information acquired during the execution of the establish connection 35 block.

The transmit compressed image 35 block sends the compressed image data to the remote display.

It will be appreciated that the invention is not restricted to the particular embodiment that has been described, and that variations may be made therein without departing from the scope of the invention as defined in the appended claims and equivalents thereof. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. Further, a reference in the foregoing description to an element, be it a reference to one instance of that element or more than one instance, is not intended to imply that any claim should be interpreted as if it required that element or that embodiments of the invention could not be implemented without that element.

1. A remote access device for use with a local computer to allow a remote computer to interact with the local computer, said remote access device comprising:
a local computer interface for receiving signals from, and transmitting signals to, a bus of the local computer,
a graphics circuit for receiving graphics messages from the local computer and converting the graphics messages to image data,
an encoder for receiving the image data and packaging the image data for transmission, and
a communication interface for receiving the packaged image data and transmitting the packaged image data over a communication medium to the remote computer.

2. A remote access device according to claim 1, wherein the graphics circuit is responsive to a display update request to acquire image data from the bus of the local computer via the local computer interface and to provide the image data to the encoder for packaging.

3. A remote access device according to claim 1, wherein the graphics circuit is a graphics engine that is responsive to a display update request received from the remote computer via the communication interface to acquire image data from the bus of the local computer via the local computer interface and to provide the image data to the encoder for packaging.

4. A remote access device according to claim 1, wherein the encoder responds to a display device update request received from the remote computer via the communication interface by requesting image data from the graphics engine and packaging the image data for transmission.

5. A remote access device according to claim 1, wherein the encoder comprises a microprocessor that is programmed to respond to a display device update request received from the remote computer via the communication interface by requesting image data from the graphics engine and packaging the image data for transmission.

6. A remote access device according to claim 1, wherein the encoder and the communication interface manage communication between the encoder and the communication medium and respond to a display device update request received from the remote computer via the communication medium by requesting image data from the graphics engine and packaging the image data for transmission over the communication medium.

7. A remote access device according to claim 1, wherein the encoder and the communication interface comprise a microprocessor that is programmed to manage communication between the encoder and the communication medium and to respond to a display device update request received from the remote computer via the communication medium by requesting image data from the graphics engine and packaging the image data for transmission over the communication medium.

8. A computer system comprising:
a local computer having a bus and a communication interface,
a remote computer having a processor, a user interface including a display monitor, and a communication interface,
a communication medium for communicating messages between the communication interfaces of the local and remote computers, and
a remote access device comprising a local computer interface for receiving signals from, and transmitting signals to, the bus of the local computer, a graphics circuit for receiving graphics messages from the local computer and converting the graphics messages to image data representing an image, an encoder for receiving the image data, packaging the image data for transmission, and delivering the packaged image data to the communication interface of the local computer for transmission over the communication medium to the communication interface of the remote computer,
and wherein the communication interface of the remote computer delivers the packaged image data to the processor of the remote computer, and the remote computer is programmed to display a replica of said image on the display monitor.

9. A computer system according to claim 8, comprising a plurality of local computers each having a bus and a communication interface, and a plurality of remote access devices associated with the local computers respectively and each comprising a local computer interface for receiving signals from, and transmitting signals to, the bus of the associated local computer, a graphics circuit for receiving graphics messages from the associated local computer and converting the graphics messages to image data representing an image, an encoder for receiving the image data, packaging the image data for transmission, and delivering the packaged image data to the communication interface of the associated local computer for transmission over the communication medium to the communication interface of the remote computer.

10. A computer system comprising:
a local computer having a bus,
a remote computer having a processor, a user interface including a display monitor, and a communication interface,
a remote access device comprising a local computer interface for receiving signals from, and transmitting signals to, the bus of the local computer, a graphics circuit for receiving graphics messages from the local computer and converting the graphics messages to image data representing an image, an encoder for receiving the image data and packaging the image data for transmission, and a communication interface for receiving the packaged image data and transmitting the packaged image data,
a communication medium for transmitting the packaged image data from the communication interface of the remote access device to the communication interface of the remote computer,
and wherein the communication interface of the remote computer delivers the packaged image data to the processor of the remote computer, and the remote computer is programmed to display a replica of said image on the display monitor.

11. A computer system according to claim 10, comprising a plurality of local computers each having a bus and a plurality of remote access devices associated with the local computers respectively and each comprising a local computer interface for receiving signals from, and transmitting signals to, the bus of the associated local computer, a graphics circuit for receiving graphics messages from the associated local computer and converting the graphics messages to image data representing an image, an encoder for receiving the image data and packaging the image data for transmission, and a communication interface for receiving the packaged image data and transmitting the packaged image data,
and wherein the communication medium is connected to the communication interfaces of the remote access devices for transmitting the packaged image data from the communication interfaces of the remote access devices to the communication interface of the remote computer, and the communication interface of the remote computer delivers the packaged image data to the processor of the remote computer, and the remote computer is programmed to display a replica of said image on the display monitor.
